(19) United States
(12) Patent Application Publication
(10) Pub. No.: US 2020/0037597 A1
(43) Pub. Date: Feb. 6, 2020

(54) Device for preventing tick bites and method for manufacturing the same

(71) Applicants: Liviu Victor Rusu, Saratoga Springs, NY (US); Matthew Wilson Westfall, Jersey City, NJ (US)

(72) Inventors: Liviu Victor Rusu, Saratoga Springs, NY (US); Matthew Wilson Westfall, Jersey City, NJ (US)

(21) Appl. No.: 16/533,443

(22) Filed: Aug. 6, 2019

Related U.S. Application Data
(60) Provisional application No. 62/714,860, filed on Aug. 6, 2018.

(51) Int. Cl. A01M 1/14; A01M 1/02; A01N 25/24; A01N 25/10; A01N 27/00; A01N 25/34

(52) U.S. Cl. CPC A01M 1/14; A01M 1/023; A01N 25/34; A01N 25/10; A01N 27/00; A01N 25/24

(57) ABSTRACT

Wearable articles, such as adhesive tapes, for prevention of tick and other pest bites includes flexible substrates having first and second opposite sides. The first side includes an adhesive configured to adhere the article to a user's skin, while the second side includes an attractant site configured to attract the pest, and a trap site configured to trap the pest. Methods for making an adhesive tape for the prevention of tick bites include providing such a substrate, placing a skin adhesive on one surface, and placing a chemoattractant and tick or insect adhesive on the second surface.

### CROSS-REFERENCE TO RELATED APPLICATIONS

This application claims the benefit of U.S. Provisional Application No. 62/714,860, filed Aug. 6, 2018, incorporated herein by reference in its entirety.

### TECHNICAL FIELD

The present disclosure generally relates to wearable articles to prevent tick bites and, more particularly, to disposable adhesive tapes adhered to a user's skin to prevent tick bites.

### BACKGROUND

Ticks of various species are notorious transmission vectors of multiple human and animal diseases, including Lyme disease, tularemia, Rocky Mountain spotted fever, anaplasmosis, ehrlichiosis, and others. Ticks and tick-borne diseases are especially prevalent in areas having dense deer populations, because Ixodes scapularis, or deer ticks, are common disease vectors. Such areas include large swathes of the United States, including several heavily human populated areas, causing Lyme disease in particular to be a significant health problem.

Conventional methods for preventing tick-borne disease include avoiding wooded areas where ticks are most likely to be present, visual self-inspection and manual tick removal whenever passing through such areas, and use frequent use of chemical insect/arachnid repellents, such as N,N-Diethyl-m-toluamide (DEET). However, frequent use of DEET and other chemical repellents can have undesirable side effects and health consequences for the user.

Accordingly, it would be desirable to provide effective materials and methods for tick bite prevention that do not employ chemical repellents.

### SUMMARY

This section provides a general summary of the disclosure, and is not a comprehensive disclosure of its full scope or all of its features.

In various aspects, the present teachings provide an adhesive tape to prevent insect bites on a user's skin. The tape includes a flexible fabric substrate having a first surface, and a second surface opposite the first surface. The tape also includes a first adhesive layer coating at least a portion of the first surface and configured to contactingly adhere the first surface to the user's skin. The tape further includes a second adhesive layer coating at least a portion of the second surface. The second adhesive layer includes an outer layer having a first adhesive strength and an inner layer, interposed between the substrate and the outer layer and having a second adhesive strength, the second adhesive strength being less than the first adhesive strength. The tape further includes a squalene deposit entrained in a central portion of the outer layer.

In other aspects, the present teachings provide a method for manufacturing a tick bite prevention tape. The method includes a step of providing a flexible planar substrate having a first surface and a second surface opposite the first surface. The method further includes a step of coating, at least partially, the first surface with a skin adhesive configured to reversibly adhere the tape to a user's skin. The method additionally includes a step of impregnating an attractant site, that is located on the second surface, with an attractant composition having at least one chemoattractant effective to attract ticks. The method also includes a step of positioning a tick adhesive, configured to adhesively capture a tick, at a trap site positioned at or near the attractant site.

In yet other aspects, the present teachings provide a wearable article to prevent tick bites on a user's skin. The wearable article includes a flexible planar substrate having a first surface and a second surface opposite the first surface. The first surface is at least partially coated with a skin adhesive configured to reversibly adhere the adhesive tape to a user's skin. The second surface includes an attractant site and a trap site. The attractant site has an attractant composition that includes at least one chemoattractant configured to attract ticks. The trap site includes a tick adhesive that coats at least a portion of the trap site, and that is configured to adhesively capture a tick at the trap site.

Further areas of applicability and various methods of enhancing the disclosed technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1 is front plan view of a user 10 wearing a wearable article 100 of the present teachings;

FIG. 2A is a plan view of an adhesive tape representing a wearable article of the present teachings; and

FIG. 2B is a plan view of the adhesive tape of FIG. 2A, viewed from an opposite angle and thereby showing the opposite surface of the tape.

It should be noted that the figures set forth herein are intended to exemplify the general characteristics of the methods, algorithms, and devices among those of the present technology, for the purpose of the description of certain aspects. These figures may not precisely reflect the characteristics of any given aspect, and are not necessarily intended to define or limit specific embodiments within the scope of this technology.

### DETAILED DESCRIPTION

The present teachings provide disposable tape and other wearable articles that prevent bites from ticks and other arachnids such as various mites. The wearable articles of the present teachings provide effective protection while eliminating the need for chemical repellents, such as N,N-Diethyl-m-toluamide (DEET), applied to the skin. As such, the wearable articles of the present teachings avoid health risks and physiological irritations associated with exposure to DEET and other repellents.

Wearable articles of the present teachings can, in certain implementations, include a tape that is directly adhered to the skin of a user. Disclosed wearable articles include an attractant, configured to attract ticks or other target pests onto the articles. They further include a capture adhesive that captures the pest and prevents it from leaving the article, thereby preventing bites. It will be noted that, in various implementations, ticks of various species represent a target pest of particular interest. As such, the terms “tick” and “target pest” will at times be used interchangeably herein. It will be understood, however, that the design features of wearable articles of the present teachings can be adapted to other (i.e. non-tick) target pests.

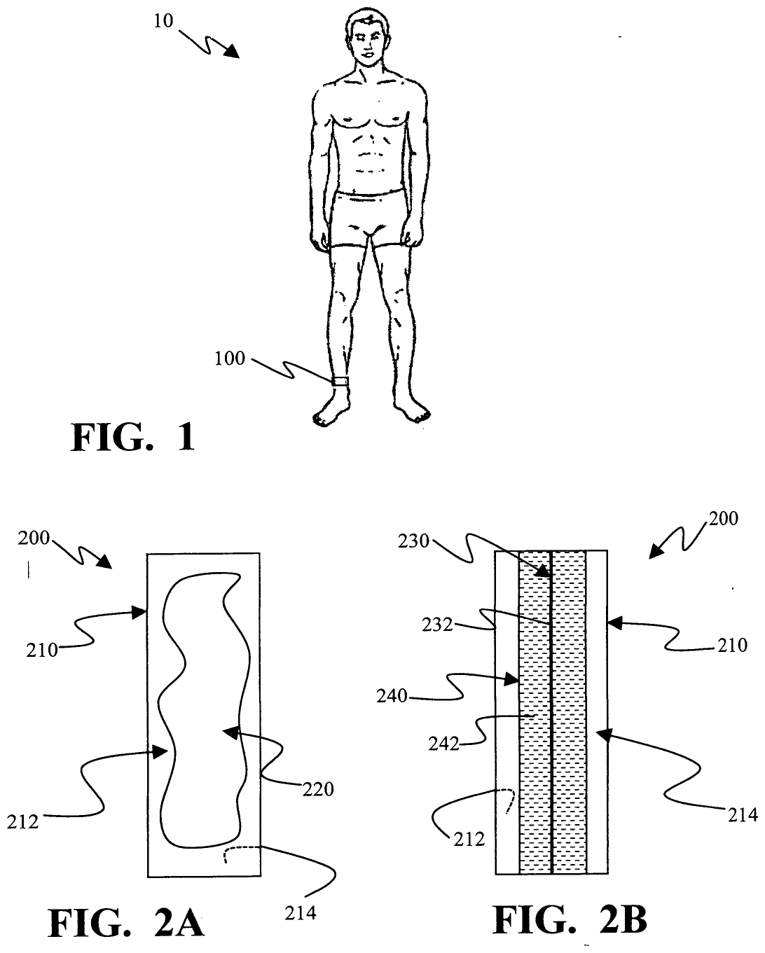

FIG. 1 shows front plan view of a user 10 wearing a wearable article 100 of the present teachings. The wearable article 100 of FIG. 1 is worn around the ankle, as this may be an advantageous location for a user 10 to wear a wearable article 100 of the present teachings, when walking through woods, near brush, or in other areas likely to contain ticks or other target pests. It will be appreciated, however, that a wearable article 100 of the present teachings can be worn on any location on the body, such as on a wrist, on the neck, or at any other bodily location.

FIGS. 2A and 2B shows plan views of an adhesive tape 200, representing an exemplary implementation of a wearable article 100 of the present teachings, the plan views of FIGS. 2A and 2B taken from opposite angles. Stated alternatively, the view of FIG. 2B is that of FIG. 2A after the adhesive tape 200 has been “flipped over.” The adhesive tape 200 includes a flexible planar substrate 210 having a first surface 212 and a second surface 214 that is opposite the first surface. It will be understood that the expression “flexible planar substrate” indicates that the substrate 210 is not rigidly planar, but can be readily folded, bent, curved, coiled, etc. As such, the flexible planar substrate 210 can be formed of a plastic; a paper, or paper-like product formed substantially of cellulose; a natural or synthetic fabric, such as fabrics commonly used in various medical tapes; or any other suitable material. The flexible planar substrate 210 can be of any color or combination of colors, but in certain implementations can be primarily white. The flexible planar substrate 210 can be characterized as having a length and a width, and in many implementations the width can be uniform over the entire length. In various implementations, the width can be within a range of from about 0.5 inches to about 3 inches, and the length can be within a range of from several inches to tens of feet, or more. In some implementations, the adhesive tape 200 can be provided in a roll, in which the flexible planar substrate 210 has a width of about 1.5 inches and a length of about 15 feet.

The first surface 212 can be at least partially coated with a skin adhesive 220, configured to stably but reversibly adhere the tape 200 to a user's skin. Non-limiting examples of compositions usable in the skin adhesive include various rubbers, acrylics, silicones, or any other suitable composition. The second surface 214 includes an attractant site 230 that is at least partially coated with, impregnated with, or otherwise carries an attractant composition 232 that includes at least one chemoattractant to which a target pest will be attracted. In many implementations the target pest will include one or more species of tick, such as Ixodes scapularis; and in such implementations, the chemoattractant can include: squalene; 2,6-dichlorophenol; various cholesterol esters, compounds effective to release carbon dioxide or ammonia; or any other effective chemoattractant. In certain specific implementations, the chemoattractant can include squalene.

In some implementations, the attractant composition 232 can be soaked or impregnated directly into the flexible planar substrate 210. In other implementations, the second surface 214 can include an additional fabric, such as a wick, or another porous material located at the attractant site 230 and that is soaked or impregnated with attractant composition. In some implementations, the attractant composition 232 can include a carrier component, such as a solvent, oil, or other liquid in which the chemoattractant is dissolved, suspended, emulsified, or otherwise dispersed.

The second surface 214 can further include a trap site 240 configured to prevent a tick or other target pest that treads on or enters the trap site 240 from leaving the trap site 240. This can be stated alternatively as, the trap site traps the target pest. In certain implementations, the trap site 240 can include a tick adhesive 242 coating the second surface 214 at the trap site 240, and configured to adhesively capture a tick at the trap site 242. Such adhesive capture thus prevents a tick from leaving the trap site 242. Non-limiting examples of suitable tick adhesives 242 can include glues; waxes; syrups; or any other viscous liquid, semi-liquid, or semi-solid having sufficient adhesive force to entrain the target pest. In some implementations, the trap site 230 can include one or more physical barriers, such as various protrusions, ridges, etc. configured to slow ambulatory progress of a tick migrating across the trap site 240. Such physical barriers, when combined with a tick adhesive 242, can improve the effectiveness of the tick adhesive 242 by slowing the tick and causing it to reside for a longer duration in the trap site 240.

In various implementations, the attractant site 230 and the trap site 240 can be at least partially co-localized, can be adjacent to one another, and/or can be spaced apart from one another. In many implementations, it will be desirable that the entire attractant site 230 is co-localized with the trap site 240; surrounded by the trap site 240; or otherwise configured so that any ambulatory pathway from the user's 10 skin to the attractant site 230 will cross the trap site 240. It will thus be understood that the combination of attractant site 230 and trap site 240, as described above, results in a scenario in which a tick on a user's 10 body will be sense the chemoattractant 232 at the attractant site 230 and will therefore tend to migrate to the attractant site 230. Upon approaching the attractant site 230, the tick will necessarily tread upon or enter the trap site 240, which will enduringly detain the tick at that location. This attraction/detention regime will thus tend to permanently localize any infesting ticks on the adhesive tape 200, thereby preventing them from biting the user 10.

It will be understood that, in a typical encounter, a tick crawls onto a human's foot or arm and makes its way up the arm or leg until it finds a suitable spot on which to latch. This spot is typically an area with a natural concentration of squalene. It is a warm, oily spot protected by the hairline or a fold in the skin. Once the tick has found a suitable spot it latches on and begins to feed on the human's blood. During this time, it may transmit disease by passing microorganisms that cause Lyme or other disease into the wound. Such disease transmission typically requires that the tick be latched onto the wound for 12-36 hours. Tapes and wearable articles of the present disclosure prevent such disease transmission by attracting a tick once it is on the user, and then trapping it on the tape before the tick has any chance to latch on and feed. The article attracts the ticks with the use of squalene which is administered on the tape and then traps it as it tries to get to the squalene. By doing this the tape or other wearable article mitigates the tick long before there is any chance of spreading disease.

It will thus be understood that, while the exemplary wearable article 100 described above is an adhesive tape 200, the concepts provided herein can be applied to virtually any other wearable article, such as a slap bracelet, socks, wrist bands, or any other wearable article that a tick would be able to walk onto. Many such alternative implementations can exclude the skin adhesive 220.

Also disclosed is a method for manufacturing a tick bite prevention tape. The method includes a step of providing a flexible planar substrate 210 having a first surface 212 and a second surface 214 opposite the first surface 212. The method also includes a step of coating, at least partially, the first surface 212 with a skin adhesive 220 configured to stably adhere the tape to a user's skin. The method further includes a step of impregnating an attractant site 230 on the second surface 214 with an attractant composition 232 having at least one chemoattractant effective to attract ticks. The method further includes positioning a tick adhesive 242, configured to adhesively capture a tick, at a trap site 240 that either surrounds the attractant site 230 or co-localizes with the entire attractant site 230. The method can optionally include a step of placing physical barriers at the trip site 230. It will be understood that, in instances in which terms used to describe the method here are identical to terms used to describe the adhesive tape 200 above, those terms having identical meaning with respect to the method as the definitions provided above with respect to the adhesive tape 200.

The present invention is further illustrated with respect to the following examples. It needs to be understood that these examples are provided to illustrate specific embodiments of the present invention and should not be construed as limiting the scope of the present invention.

### EXAMPLE 1

### Adhesive Tape and Fabrication and Use Thereof

A tape substrate is provided or fabricated in one inch wide by 15 foot long rolls. It is a medical grade, white tape substrate. An adhesive with heavy tackiness is coated on one side of the substrate, and a logo or other insignia, words, etc. can optionally be printed on the other. In the middle of the tape, on the adhesive side and for the entire 15′ length of the tape, there is a line, continuum, or periodicity of squalene added. The squalene can be added by soaking a string in squalene until 100% concentration and then adding to the tape, soaking a paper string in squalene until 100% concentration and then adding to the tape or simply by spraying the attractant on to the adhesive side of the tape. There can optionally be a wax liner intercoiled with the tape that keeps the attractant and logo from peeling off, and the squalene from going rancid during storage. The tape is preferably white because that is the color which ticks are attracted to the most. While other attractants can be used, squalene is preferred due to its strong chemoattractant quality. A user can unwind the roll of tape and cut or tear the appropriate length to wrap around the ankle, leg, wrist, arm or neck and then wrap the tape around his/her appendage with the adhesive side out and fasten it to itself using the adhesive side as the fastener. After the user is done with whatever outdoor activity he/she is engaged in, he/she can simply remove the tape by tearing it off and then throwing it in the garbage. Any ticks that have been caught by the tape are mitigated and disposed of without the ability to spread disease.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. An adhesive tape to prevent insect bites on a user's skin, the tape comprising:
a flexible planar substrate having:
a first surface that is at least partially coated with a skin adhesive configured to reversibly adhere the adhesive tape to a user's skin; and
a second surface opposite the first surface, the second surface having:
an attractant site having an attractant composition that includes at least one chemoattractant configured to attract a target insect; and
a trap site configured to trap the target pest.

2. The adhesive tape as recited in claim 1, wherein the target insect comprises one or more species of ticks, and the at least one chemoattractant is configured to attract said one or more species of ticks.

3. The adhesive tape as recited in claim 1, wherein the at least one chemoattractant is selected from the group consisting of: squalene; 2,6-dichlorophenol; various cholesterol esters, and compounds effective to release carbon dioxide or ammonia.

4. The adhesive tape as recited in claim 1, wherein the at least one chemoattractant comprises squalene.

5. The adhesive tape as recited in claim 1, wherein the attractant composition is soaked or impregnated directly into the flexible planar substrate.

6. The adhesive tape as recited in claim 1, wherein the attractant site comprises an additional fabric or other porous material that is soaked or impregnated with the attractant composition.

7. The adhesive tape as recited in claim 1, wherein the attractant composition includes a carrier component in which the chemoattractant is dissolved, suspended, emulsified, or otherwise dispersed.

8. The adhesive tape as recited in claim, wherein the trap site further comprises one or more physical barriers configured to slow ambulatory progress of a tick migrating across the trap site.

9. The adhesive tape as recited in claim 8, wherein the one or more physical barriers comprise one or more ridges.

10. The adhesive tape as recited in claim 1, wherein the flexible planar substrate comprises a plastic.

11. The adhesive tape as recited in claim 1, wherein the flexible planar substrate comprises a paper or paper-like product formed substantially of cellulose.

12. The adhesive tape as recited in claim 1, wherein the flexible planar substrate comprises a natural or synthetic fabric.

13. A method for manufacturing a tick bite prevention tape, the method comprising:
providing a flexible planar substrate having a first surface and a second surface opposite the first surface;
coating, at least partially, the first surface with a skin adhesive configured to stably adhere the tape to a user's skin;
impregnating an attractant site, that is located on the second surface, with an attractant composition having at least one chemoattractant effective to attract ticks;
positioning a tick adhesive, configured to adhesively capture a tick, at a trap site positioned on the second surface at or near the attractant site.

14. The method as recited in claim 13, wherein the trap site substantially overlaps the attractant site.

15. The method as recited in claim 13, wherein the trap site substantially surrounds the attractant site.

16. The method as recited in claim 13, further comprising:
placing one or more physical barriers at the trap site, the one or more physical barriers configured to impede a trick from exiting the trap site.

17. A wearable article to prevent tick bites on a user's skin, the wearable article comprising:
a flexible planar substrate having:
a first surface that is at least partially coated with a skin adhesive configured to reversibly adhere the adhesive tape to a user's skin; and
a second surface opposite the first surface, the second surface having:
an attractant site having an attractant composition that includes at least one chemoattractant configured to attract ticks; and
a trap site having a tick adhesive that coats at least a portion of the trap site, and that is configured to adhesively capture a tick at the trap site.

18. The wearable article as recited in claim 17, wherein the at least one chemoattractant comprises squalene.

19. The wearable article as recited in claim 17, wherein the attractant site and the trap site substantially overlap.

20. The wearable article as recited in claim 17, wherein the trap site substantially surrounds the attractant site.
